(19) United States
(12) Patent Application Publication
(10) Pub. No.: US 2026/0175401 A1
(43) Pub. Date: Jun. 25, 2026

(54) CENTER-OF-GRAVITY ADAPTER FOR ROTATING ENGINE STAND

(71) Applicant: Robert Bosch GmbH, Stuttgart (DE)

(72) Inventors: Daniel Newkirk, Owatonna, MN (US); Gustavo Fontana, Rochester, MN (US)

(21) Appl. No.: 19/425,208

(22) Filed: Dec. 18, 2025

Related U.S. Application Data
(60) Provisional application No. 63/738,074, filed on Dec. 23, 2024.

(51) Int. Cl. B25H 1/00

(52) U.S. Cl. CPC B25H 1/0007

(57) ABSTRACT

An engine stand having rotating features and an adapter to adjust the position of the center of gravity of a mounted engine. The adapter comprises a backing body and an adjustment body, the adjustment body having an adjustable linear displacement with respect to the backing body and a rotation axis of the engine stand. The linear displacement of the adjustment body is adjusted via a forcing screw.

### TECHNICAL FIELD

This disclosure relates to specialty tools for use in automotive service. In particular, this disclosure relates to engine stands.

### BACKGROUND

Rotating engine stands are useful in order to optimally position an engine during service for work, such as repair, removal of a component, addition or a component, or replacement of a component. Large automotive engines may have large and unwieldly weights, sometimes in excess of 6,000 pounds. In addition to being very heavy, the weight of an engine is not uniformly dispersed throughout its volume, making for irregularly positioned centers of gravity. A center of gravity that is disposed far from the axis of rotation can make manual rotation of the engine difficult during service.

What is desired is a mechanism that can minimize the distance of an engine's center of gravity from the axis of rotation of the rotating engine stand. It would be additionally advantageous if this adjustment can be accomplished at any point during service of the engine to maximize efficiency for the user.

### SUMMARY

One aspect of this disclosure is directed an engine stand adapter comprised of a backing body and an adjustment body. The backing body has a connector compatible with a rotating arm of a rotating engine stand. The adjustment body is coupled to the backing body and compatible with a mounting plate of a rotating engine stand. A rotation axis is defined by the rotating arm of the engine stand. The adjustment body is coupled to the backing body via a forcing screw. The adjustment body is adjustably displaced relative to the backing body along a linear direction perpendicular to the rotation axis via rotation of the forcing screw.

Another aspect of this disclosure is directed to a rotating engine stand having a support member, a rotating arm extending from the support member, a rotating mechanism that rotates the rotating arm around a rotation axis when engaged, a mounting plate compatible with the rotating arm, and an adapter. The adapter comprises a backing body and an adjustment body. The backing body has a connector compatible with a rotating arm of a rotating engine stand. The adjustment body is coupled to the backing body and compatible with a mounting plate of a rotating engine stand. The adjustment body is coupled to the backing body via a forcing screw. The adjustment body is adjustably displaced relative to the backing body along a linear direction perpendicular to the rotation axis via rotation of the forcing screw. The adapter is disposed between the rotating arm and the mounting plate when the rotating engine stand is assembled.

The above aspects of this disclosure and other aspects will be explained in greater detail below with reference to the attached drawings.

### BRIEF DESCRIPTION OF THE DRAWINGS

FIG. 1 is an illustration of a rotating engine stand with a center-of-gravity adapter.

FIG. 2 is an exploded view of the rotating engine stand of FIG. 1.

FIG. 3 is a close-up view of a stand adapter.

FIG. 4 is an illustration of a backing body of a stand adapter.

FIG. 5 is an illustration of a rotating engine stand supporting an engine during service.

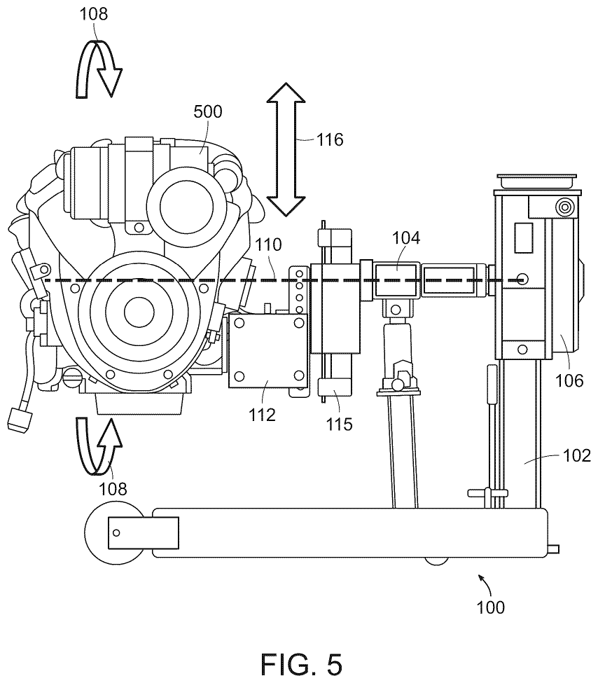

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

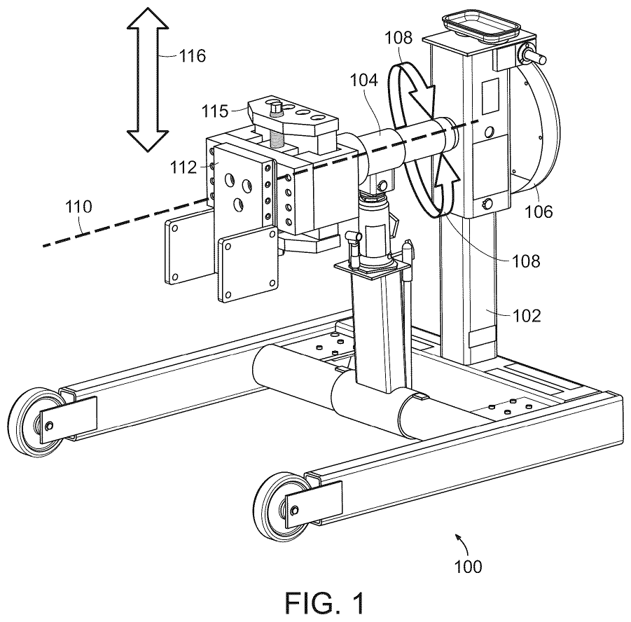

FIG. 1 is an illustration of an engine stand 100 with rotational features. Engine stand 100 comprises a support member 102 providing upright support to hold an engine for service. Extending from the support member 102 is a rotating arm 104 is rotatable via a rotating mechanism 106 in a direction 108 around a rotation axis 110. Utilization of rotating mechanism 106 to rotate rotating arm 104 advantageously permits a user to optimally position an engine when mounted (not shown) for the most convenient placement to perform service on the mounted engine.

An engine is suitable coupled to engine stand 100 via a mounting plate 112. Mounting plate 112 is depicted here as comprising a mounting base and a pair of flanges, but other embodiments may comprise other configurations without deviating from the teachings disclosed herein. Different embodiments of mounting plate 112 advantageously provide different optimal mounting for engines of a variety of sizes, shapes, and specifications.

Engines may comprise unwieldly shapes and weights when mounted, and rotation of the engine using rotating mechanism 106 may prove challenging when there is a sufficient imbalance in the distribution of the engine while mounted relative to rotation axis 110. For this reason, an adapter 115 is advantageously utilized to adjust the position of an engine in a linear direction 116 relative to rotation axis 110. Adjustment along linear direction 116 advantageously can move an engine's center-of-gravity closer to rotation axis 110, optimizing the ease with which an engine can be rotationally positioned by rotation mechanism 106 (and additionally optimizing the stability of the positioning with respect to rotational direction 108). In the depicted embodiment, adapter 115 is disposed between mounting plate 112 and rotational arm 104, but other embodiments may comprise other configurations without deviating from the teachings disclosed herein.

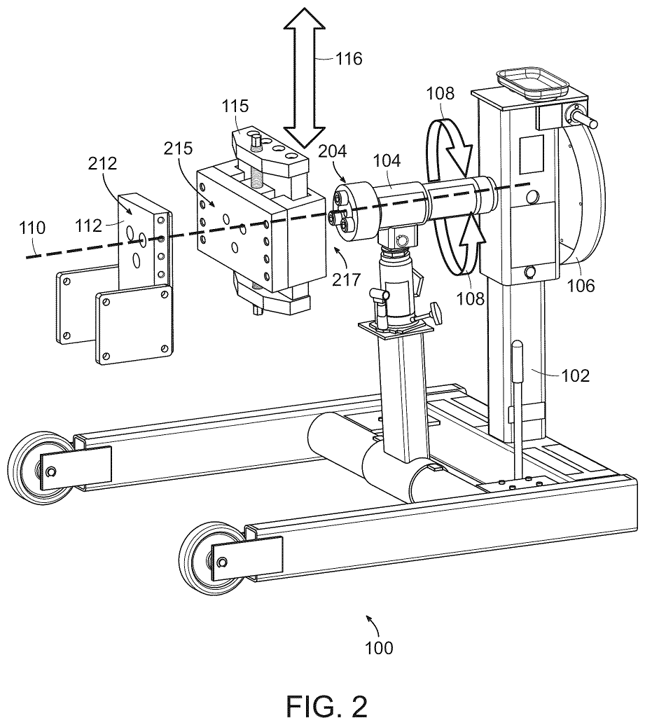

FIG. 2 is an exploded view of engine stand 100. In this view additional features can be observed. In particular, each of rotation arm 104, mounting plate 112, and adapter 115 comprise an arrangement of hardware suitable for coupling the components during assembly and mounting an engine (not shown). Rotation arm 104 comprises a geometric arrangement of fasteners 204 that is compatible with a corresponding geometric arrangement of mounting holes 212 on mounting plate 112. Additionally, a similarly compatible geometric arrangement of mounting hardware 215 and 217 are present on adapter 115 to ensure compatibility with the other components of the engine stand 100. In the depicted embodiment, the geometric arrangement of mounting hardware for each of the components comprises a triangular arrangement of threads or fasteners. The triangular arrangement advantageously prevents rotational forces from rotating mechanism 106 to inadvertently rotate any of the mounting hardware (in particular fasteners 204), which could result in an “unscrewing” effect that may destabilize the mount of the engine. Instead, by placing the threads and fasteners offset from the rotation axis 110 with a degree of regular rotational symmetry, the threads instead optimally transfer torque from rotation arm 104 to mounting plate 112, and subsequently to any engine mounted thereupon.

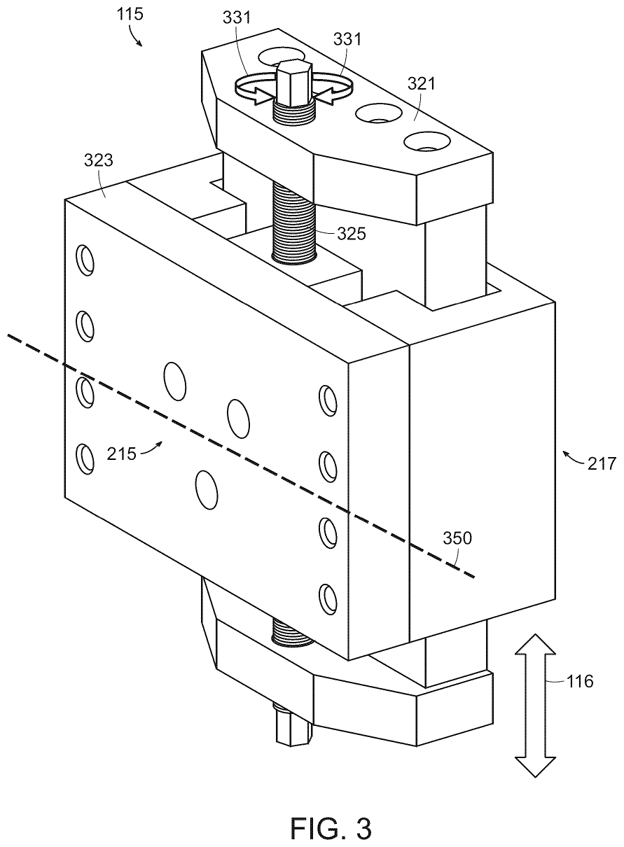

Additional features of adapter 115 are visible in FIG. 3. Adapter 115 comprises a backing body 321 coupled with an adjustment body 323 via a forcing screw 325. In the depicted embodiment, adjustment body 323 comprises a u-channel body which advantageously stabilizes the coupling between adjustment body 323 and backing body 321, but other embodiments may comprise a different configuration without deviating from the teachings disclosed herein. Rotation of forcing screw 325 in a rotational direction 331 results in a translation of the relative position between adjustment body 323 and backing body 321 along a linear direction 116. In the depicted embodiment, a clockwise adjustment of forcing screw 325 results in a first “upward” or “positive” translation of adjustment body 323, while a counter-clockwise adjustment results in a second “downward” or “negative” translation of adjustment body 323. In this example, “upward,” “positive,” “downward,” and “negative” are all defined relative to the orientation of backing body 321, and may correspond to other direction with respect to the surrounding environment because adapter 115 is designed to be coupled to rotating arm 104 (see FIG. 1, FIG. 2).

In the depicted embodiment, adjustment body 323 is shown at a median position, for a “neutral” displacement, wherein the centerpoint of adjustment body 323 is aligned with a median line 350 defining the middle of backing body 321 with respect to direction 116, but other embodiments may be depicted at various degrees of displacement without deviating from the teachings disclosed herein. By way of example, and not limitation, adjustment body 323 may be displaced along direction 116 by at least 4 inches from the median position without deviating from the teachings disclosed herein.

In the depicted embodiment, a single forcing screw 325 is utilized to provide coupling between backing body 321 and adjustment body 323, as well as drive displacement of adjustment body 323. Other embodiments may comprise other features without deviating from the teachings disclosed herein. In some such embodiments, one or more rails (not shown) may be utilized to stabilize the coupling between backing body 321 and adjustment body 323.

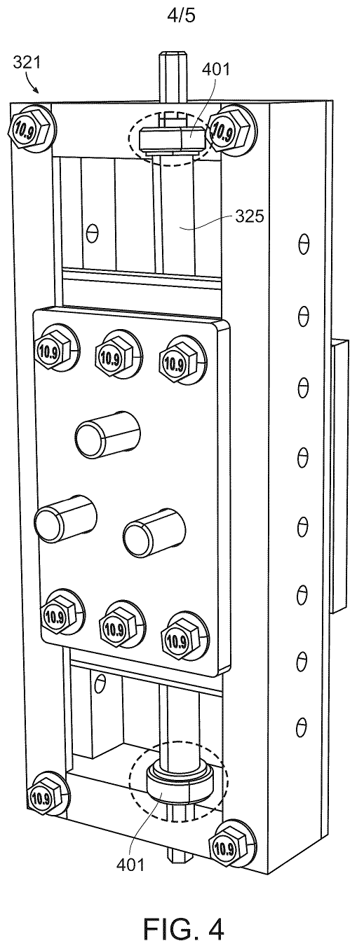

Additional features of backing body 321 are illustrated in FIG. 4. In this embodiment, either end of forcing screw 325 comprises a thrust bearing 401. Each thrust bearing 401 provides a stable contact point for the coupling between backing body 321 and adjustment body 323 (not shown; see FIG. 3), while permitting the rotation of forcing screw 325 and the linear displacement of adjustment body 323. In the depicted embodiment, backing body comprises a pair of thrust bearings 401, but other embodiments may comprise a different configuration without deviating from the teachings disclosed herein.

Backing body 321 may additionally comprise a number of rollers displaced between backing body 321 and adjustment body 323 during assembly of adapter 115. The rollers are suitable to stabilize the coupling of adjustment body 323 with backing body 321 and also reduce friction during linear displacement of adjustment body 323.

FIG. 6 is a diagrammatic illustration of engine stand 100 supporting an engine 500. Engine 500 is rotatable about rotation axis 110 along rotational direction 108, but its center of gravity may be adjustably positioned closer to rotation axis 110 by linear displacement of adapter 115 (specifically adjustment body 323; see FIG. 3). Repositioning of the center of gravity of engine 500 advantageously reduces the torque necessary for rotating mechanism 106 to provide for rotation of rotating arm 104 along direction 108, and additionally advantageously makes the positioning in a particular rotational position more stable. Notably, the depicted linear displacement along direction 116 is defined with respect to the linear displacement of adjustment body 323 with respect to rotation axis 110. Although direction 116 is depicted defining an “up/down” linear direction, the orientation of direction 116 correlates with the orientation of 115. Rotation of adapter 115 (and by proxy, of engine 500) changes the relative orientation of direction 116 with respect to non-rotating components of engine stand 100 (such as support member 102), but direction 116 is always transverse relative to rotation axis 110. This advantageously makes the adjustment of the position of engine 500 always relevant to rotation axis 110, which is important as engine 500 may comprise a great deal of irregular weight. In the depicted embodiment, engine 500 may weight 6,000 pounds, but other embodiments may comprise a different configuration without deviating from the teachings disclosed herein. Other such embodiments may comprise engines 500 having weights of 1000 pounds, 3000 pounds, 10,000 pounds, or any other weight without deviating from the teachings disclosed herein. It is important that all load-bearing components of engine stand 100 be sufficiently robust to properly support the weight of engine 500 without failure. In the depicted embodiment, each of the load-bearing components of engine stand 500 are suitable to support at least 6,000 pounds, but other embodiments suitable for a different engine design may comprise a different load limit without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An engine stand adapter comprising:
a backing body having a connector compatible with a rotating arm of a rotating engine stand; and
an adjustment body coupled to the backing body, the adjustment body compatible with a mounting plate of a rotating engine stand,
wherein
the rotating arm defines a rotation axis,
the adjustment body is coupled to the backing body via a forcing screw, and
the adjustment body is adjustably displaced relative to the backing body along a linear direction perpendicular to the rotation axis via rotation of the forcing screw.

2. The engine stand adapter of claim 1, wherein the maximum adjustable displacement of the adjustment body is at least 4 inches along the linear direction from a median position.

3. The engine stand adapter of claim 1, further comprising a thrust bearing disposed between the forcing screw and the adjustment body, the thrust bearing disposed at one end of the forcing screw.

4. The engine stand adapter of claim 3, further comprising a pair of thrust bearings, each thrust bearing is disposed between the forcing screw and the adjustment body and further disposed at an end of the forcing screw.

5. The engine stand adapter of claim 1, wherein the backing body connector comprises a geometric arrangement of mounting holes matching a corresponding arrangement of fasteners of the rotating arm.

6. The engine stand adapter of claim 1, wherein the adjustment body comprises a geometric arrangement of mounting holes matching a corresponding arrangement of hardware of the mounting bracket.

7. The engine stand adapter of claim 1, wherein the engine stand adapter is rated to support at least 6,000 pounds.

8. A rotating engine stand having:
a support member;
a rotating arm extending from the support member;
a rotating mechanism that rotates the rotating arm around a rotation axis when engaged;
a mounting plate compatible with the rotating arm; and
an adapter comprising a backing body having a connector compatible with the rotating arm, and
an adjustment body coupled to the backing body, the adjustment body compatible with the mounting plate,
wherein
the adapter is disposed between the rotating arm and the mounting plate when the rotating engine stand is assembled,
the adjustment body is coupled to the backing body via a forcing screw, and
the adjustment body is adjustably displaced relative to the backing body along a linear direction perpendicular to the rotation axis via rotation of the forcing screw.

9. The rotating engine stand of claim 8, wherein the maximum adjustable displacement of the adjustment body is at least 4 inches along the linear direction from a median position.

10. The rotating engine stand of claim 8, further comprising a thrust bearing disposed between the forcing screw and the adjustment body, the thrust bearing disposed at one end of the forcing screw.

11. The rotating engine stand of claim 10, further comprising a pair of thrust bearings, each thrust is disposed between the forcing screw and the adjustment body and further disposed at an end of the forcing screw.

12. The rotating engine stand of claim 8, wherein the backing body connector comprises a geometric arrangement of mounting holes matching a corresponding arrangement of fasteners of the rotating arm.

13. The rotating engine stand of claim 8, wherein the adjustment body comprises a geometric arrangement of mounting holes matching a corresponding arrangement of hardware of the mounting bracket.

14. The rotating engine stand of claim 8, wherein the support member, rotating arm, rotating mechanism, mounting plate, and adapter are each rated to support at least 6,000 pounds.
